(19) United States
(12) Patent Application Publication
(10) Pub. No.: US 2018/0290934 A1
(43) Pub. Date: Oct. 11, 2018

(54) REFRACTORY METAL MATRIX-CERAMIC COMPOUND MULTI-COMPONENT COMPOSITE MATERIAL WITH SUPER-HIGH MELTING POINT

(71) Applicant: National Tsing Hua University, Hsinchu (TW)

(72) Inventor: Swe-Kai CHEN, Hsinchu (TW)

(21) Appl. No.: 15/968,972

(22) Filed: May 2, 2018

Related U.S. Application Data
(63) Continuation-in-part of application No. 14/045,908, filed on Oct. 4, 2013, now abandoned.

(30) Foreign Application Priority Data
Jun. 21, 2013 (TW) 102122225

(51) Int. Cl. C04B 35/56; C04B 35/622; C09D 1/00

(52) U.S. Cl. CPC C04B 35/5611; C04B 35/62222; C09D 1/00; C04B 35/5626; C04B 2237/40; C04B 35/5622; C04B 2237/36

(57) ABSTRACT

A refractory metal matrix-ceramic compound multi-component composite material with the super-high melting point is disclosed. At least one ceramic compound A and at least one refractory bonding metal B are fused together by the smelting process to make the multi-component composite material. The fused ingredients of the multi-component composite material are mAnB, and 2≤(m+n)≤13. The positive integer m is the number of the kinds of the ceramic components A, and the positive integer n is the number of the kinds of the refractory bonding metals B. The absolute value of the combining enthalpy of the ceramic compound A is larger than the absolute value of the combining enthalpy between the ceramic compound A and the refractory bonding metal B. The material has the properties including over 3000° C. melting point, high stability, hardness, ductility, and fusibility in high or low temperature, fast production, and low cost.

### CROSS-REFERENCE TO RELATED APPLICATION

This application is a continuation-in-part of U.S. application Ser. No. 14/045,908, filed on Oct. 4, 2013, which claims priority to Taiwan Patent Application No. 102122225, filed on Jun. 21, 2013. The above applications are both herein incorporated by reference in their entireties.

### FIELD

The present disclosure relates to a refractory metal matrix-ceramic compound multi-component composite material with super-high melting point; in particular, to a multi-component composite material (metal matrix composite material) which is made of ceramic compound “A” fused in refractory bonding metal “B”. The multi-component composite material has the properties with high melting point, high hardness, high strength, and good ductility.

### BACKGROUND

Presently, all kinds of the cemented carbides are manufactured by using sintering process, and the microstructure of the sintered product is mainly of the fine particle of the carbides (such as tungsten carbide, WC) and the cemented metal (such as cobalt, Co). When using 1600 degrees Celsius for sintering the fine particles of tungsten carbide WC and cobalt Co, the hardness and strength thereof may be relatively high, but the porosity thereof is not zero and the ductility thereof remains to be improved. On the other hand, when using arc smelting process with 3500 degrees Celsius, the porosity thereof is eliminated and the ductility thereof increases, the microstructure may be relatively large, therefore may lower the hardness and the strength.

Although the products manufactured using a sintering process have relatively high hardness and strength, the processes of sintering are exquisite and complicated, and the ductility of the product needs further improvement. Comparing with the sintering process, smelting process is relatively simple and fast, and the microstructure of the product manufactured by a smelting process is classical dendrite-interdendrite microstructure, which has zero porosity and relatively good ductility. However, if a refractory metal is used as cemented metal to replace the conventional cemented metals, such as Co and Ni, in sintering process, the refractory metal could not be in its liquid state, increasing the difficulty of using the refractory metal in the sintering process. Therefore, if a refractory metal is used as cemented metal, a smelting process is necessary for cementing the compounds with the refractory metals. In addition to having high melting points, the multi-component composite materials manufactured by the smelting process may also have the properties with high strength, high hardness, and high ductility.

### SUMMARY

The present disclosure provides a refractory metal matrix-ceramic compound multi-component composite material with a super-high melting point. In the present disclosure, both the ceramic compound A and the refractory bonding metal B are fused together by a smelting process to form multi-component composite materials. The manufactured multi-component composite materials have the properties with high melting point, high hardness, high strength, and high ductility.

As previously mentioned, the mentioned refractory metal matrix-ceramic compound multi-component composite material with the super-high melting point is made by fusing at least one ceramic compound A and at least one refractory bonding metal B through a smelting process. The fused ingredients of the multi-component composite material are mAnB, 2≤(m+n)≤13, m is the number of the kinds of the ceramic compounds A, n is the number of the kinds of the refractory bonding metals B, and m and n are positive integers. In addition, the absolute value of the combining enthalpy of the ceramic compound A is larger than the absolute value of the combining enthalpy between the ceramic compound A and the refractory bonding metal B. As such, the ingredients after the conclusion of the smelting processes are not changed.

Specifically, the ceramic compound A is a carbide, a nitride, a boride, or a silicide.

Specifically, the carbide is titanium carbide (TiC), tantalum carbide (TaC), hafnium carbide (HfC), tungsten carbide (WC), zirconium carbide (ZrC), niobium carbide (NbC), vanadium carbide (VC), chromium carbide (Cr₂C₃), or molybdenum carbide (Mo₂C).

Specifically, the nitride is titanium nitride (TiN), zirconium nitride (ZrN), hafnium nitride (HfN), tantalum nitride (TaN), vanadium nitride (VN), or niobium nitride (NbN).

Specifically, the boride is titanium boride (TiB₂), zirconium boride (ZrB₂), hafnium boride (HfB₂), tantalum boride (TaB₂), tungsten boride (WB), chromium boride (Cr₃B₂), molybdenum boride (MoB₂), or tungsten boride (W₂B).

Specifically, the silicide is tantalum silicide (TaSi₂), titanium silicide (Ti₅Si₃), zirconium silicide (Zr₆Si₅), niobium silicide (NbSi₂), molybdenum silicide (MoSi₂), or tungsten silicide (WSi₂).

Specifically, the refractory bonding metal is tungsten (W), rhenium (Re), rhodium (Rh), ruthenium (Ru), tantalum (Ta), niobium (Nb), molybdenum (Mo), hafnium (Hf), zirconium (Zr), or osmium (Os), or sometimes including iron (Fe), cobalt (Co), or nickel (Ni).

Specifically, a maximum mixture proportion and a minimum mixture proportion of each of the main ingredients of the multi-component composite material are 93 wt % and 7 wt %, respectively.

Specifically, the melting points of the ceramic compound A and the refractory bonding metal B are approximately the same.

Specifically, the refractory bonding metal B is soluble with respect to the ceramic compound A, for increasing the fusing capacity or the wettability between the A and the B.

Specifically, a plurality of minor elements can be added into the fused ingredients of the multi-component composite material.

Specifically, the multi-component composite material can be processed by a coating process.

Specifically, the material of the coating process is MCrAlY, CoCrAlY, or MCrAlY.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a schematic diagram of a manufacturing process of a refractory metal matrix-ceramic compound multi-component composite material with super-high melting point according to one embodiment of the present disclosure;

FIG. 2A shows a metal phase schematic diagram of a refractory metal matrix-ceramic compound multi-component composite material with super-high melting point according to one embodiment of the present disclosure;

FIG. 2B shows microstructure of a refractory metal matrix-ceramic compound multi-component composite material with super-high melting point according to one embodiment of the present disclosure;

FIG. 3 shows an X-ray diffraction pattern of a refractory metal matrix-ceramic compound multi-component composite material with super-high melting point according to one embodiment of the present disclosure;

FIG. 4A shows an enlarged photo of the surface of a turning tool of a refractory metal matrix-ceramic compound multi-component composite material with super-high melting point according to one embodiment of the present disclosure;

FIG. 4B shows an enlarged photo of the surface of a turning tool of a refractory metal-matrix ceramic compound multi-component composite material with super-high melting point according to one embodiment of the present disclosure; and

FIG. 5 shows an enlarged photo of the appearance of a turning tool of a refractory metal matrix-ceramic compound multi-component composite material with super-high melting point according to one embodiment of the present disclosure.

FIG. 6 shows the hardness of the exemplary samples of the present invention was tested at room temperature, 200° C., 400° C., 600° C., 800° C., and 1000° C.

FIG. 7 shows comparison of the hardness of two exemplary samples of the present invention, C6M1 and C7M1, to the hardness of two commercial carbides (C2 and C6).

### DETAILED DESCRIPTION

The technical content, features, and efficacies of the present disclosure will be clearly shown in the following descriptions of the preferred embodiments along with the drawings.

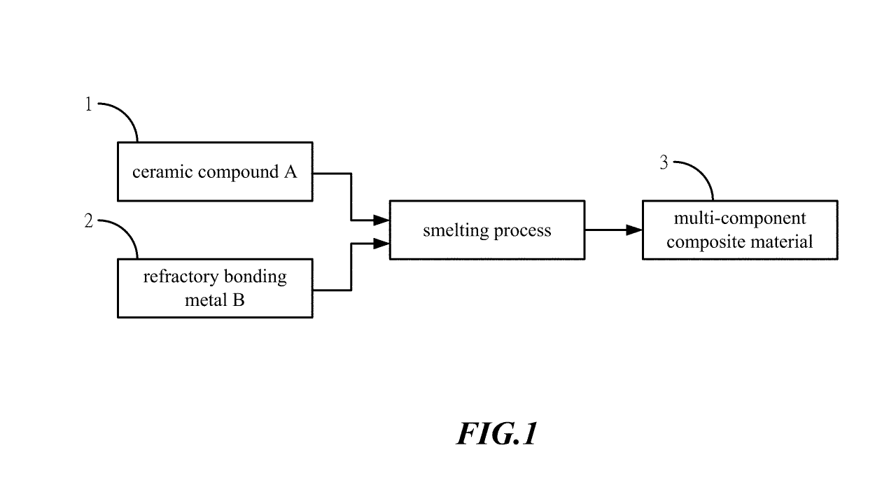

Refer to FIG. 1 which shows a manufacturing process diagram of a refractory metal matrix-ceramic compound multi-component composite material with super-high melting point according to one embodiment of the present disclosure. The multi-component composite material (3) is made by fusing at least one ceramic compound A (1) and at least one refractory bonding metal B (2) together through the smelting processes. The fused ingredients of the multi-component composite material (3) are mAnB, 2≤(m+n)≤13, and m and n are positive integers. Thus the fused ingredients may include at least one or more than one ceramic compounds A (1) and at least one or more than one refractory bonding metals B (2) (for example, if only one kind of the ceramic compound A (1) is used, the fused ingredients can be 1A1B, 1A2B, . . . , and 1A12B; in other words, there may be at most 12 refractory metals B (2) used to collocate with the ceramic compound A (1)). The maximum mixture proportion and the minimum mixture proportion of each of the main ingredients of the multi-component composite material (3) are respectively 93 wt % and 7 wt %. That is, if only one kind of ceramic compound A (1) is used, the weight percentage thereof should be at least 7% and not exceed 93% in terms of the weight percentage.

The ceramic compound A is a carbide, a nitride, a boride, or a silicide. When the smelting process is used for fusing the carbide and the refractory bonding metal, the generated multi-component composite material is a fused-refractory metal-cemented ceramic composite material or the so-called fused-refractory metal-cemented ceramics. The generated multi-component composite material is different from the composite material made by the sintering process, which is a sintered refractory metal-cemented ceramic composite material or a sintered refractory metal-cemented ceramics.

For increasing the melting point of the multi-component composite material, the refractory bonding metal replaces the common metal for serving as the cement. In addition, for fusing durable products of composite materials, the ceramic compounds A (such as the carbide, the nitride, the boride, or the silicide) and the refractory bonding metals B need to be wetting, and the better wettability ensures that the refractory bonding metals B to form the carbide, the nitride, the boride, and the silicide respectively with the carbon, the nitrogen, the boron, and the silicon without too much hardship, which may be associated with the smaller wetting angle.

The absolute value of the combining enthalpy of the ceramic compound A is larger than the absolute value of the combining enthalpy between the ceramic compound A and the refractory bonding metal B. Under this situation, when the ceramic compound A and the refractory bonding metal B are fused together, the refractory bonding metal B will not take the carbon, nitrogen, boride, and silicon of the metal elements in the ceramic compound A. Moreover, the refractory bonding metals B are able to be oxidized into compounds, and the metal elements in the ceramic compounds A are able to be reduced into the metal elements.

For example, when the ceramic compound A (TiC) is combined with the refractory bonding metal B (W), if the carbon C in TiC is taken by tungsten W, the products will easily be Ti and WC after TiC and W is combined. At the moment, although the melting points of TiC and W are respectively 3160° C. and 3410° C., the melting points of Ti and WC (which are generated after the reaction) could be lowered to 1668° C. and 2870° C., respectively. However, because the absolute value of the negative combining enthalpy of the two elements in TiC is much greater than the absolute value of the negative combining enthalpy of the two elements in WC, the above mentioned condition about the reduction at the melting point will not occur.

In addition, because the melting points of the ceramic compound A and the refractory bonding metal B are very close, the performance of the smelting process could be easier. When the ceramic compound A is at the low temperature environment, because the ceramic compound A is not a good electrical conductor at ambient temperature, the pre-heating may be necessary. Moreover, because the refractory bonding metal B is soluble with respect to the ceramic compound A, the refractory bonding metal B could be strengthened to further improve the hardness of the whole product.

In addition, after the multi-component composite material is formed using the smelting processes, the multi-component composite material may further receive thermal treatments (such as annealing and homogenizing), for improvement of its microstructure. Moreover, the multi-component composite material may further be processed by a coating process, for anti-oxidation and anti-corrosion. The usual materials used in the coating process are selected from the group includes Co, Ni, Fe, Cr, Al, Y, and Mo, and the frequently used materials are MCrAlY, CoCrAlY, and MCrAlY.

The high-temperature refractory bonding metal B used in the present disclosure is, for example, tungsten (W), rhenium (Re), rhodium (Rh), ruthenium (Ru), tantalum (Ta), niobium (Nb), molybdenum (Mo), hafnium (Hf), zirconium (Zr), or osmium (Os). However, the middle-temperature refractory metal B such as iron (Fe), cobalt (Co), or nickel (Ni) can also be used.

The ceramic compound A used in the present disclosure is, for example, a carbide, and the available high-temperature carbide may be titanium carbide (TiC), tantalum carbide (TaC), hafnium carbide (HfC), tungsten carbide (WC), zirconium carbide (ZrC), or niobium carbide (NbC). In addition, the moderately high-temperature carbide, such as vanadium carbide (VC), chromium carbide (Cr₂C₃), or molybdenum carbide (Mo₂C), may also be used.

The ceramic compound A used in the present disclosure is, for example, a nitride, and the available high-temperature nitride may be titanium nitride (TiN), zirconium nitride (ZrN), hafnium nitride (HfN), or tantalum nitride (TaN). In addition, the moderately high-temperature nitride, such as vanadium nitride (VN) or niobium nitride (NbN), can also be used.

The ceramic compound A used in the present disclosure is, for example, a boride, and the available high-temperature boride may be titanium boride (TiB₂), zirconium boride (ZrB₂), hafnium boride (HfB₂), or tantalum boride (TaB₂). In addition, the moderately high-temperature boride, such as tungsten boride (WB), chromium boride (Cr₃B₂), molybdenum boride (MoB₂), or tungsten boride (W₂B), can also be used.

The ceramic compound A in the present disclosure is, for example, a silicide, and the available high-temperature silicide may be tantalum silicide (TaSi₂). In addition, the moderately high-temperature silicide, such titanium silicide (Ti₅Si₃), zirconium silicide (Zr₆Si₅), niobium silicide (NbSi₂), molybdenum silicide (MoSi₂), or tungsten silicide (WSi₂), can also be used.

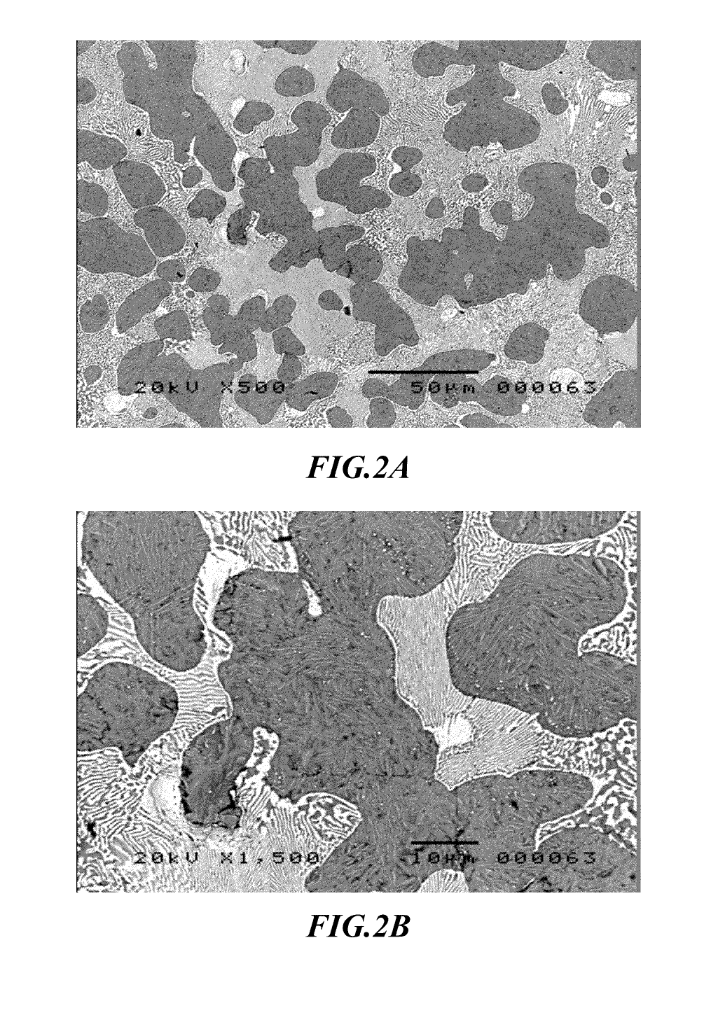

The present embodiment of the disclosure takes titanium carbide (TiC) and tungsten (W) for example. Titanium carbide (TiC) and tungsten (W) are fused together by a smelting process into a multi-component composite material. The metal phase of the multi-component composite material is shown as FIG. 2A. The pure white color phase is tungsten, the white color fingerprint phase is the eutectic phase of tungsten and titanium carbide, the black color phase is the solid solution phase of titanium carbide and tungsten, and the dark black dot phase is the pure titanium carbide phase. FIG. 2B is the enlarged photo of FIG. 2A where the above-mentioned four phases are further illustrated.

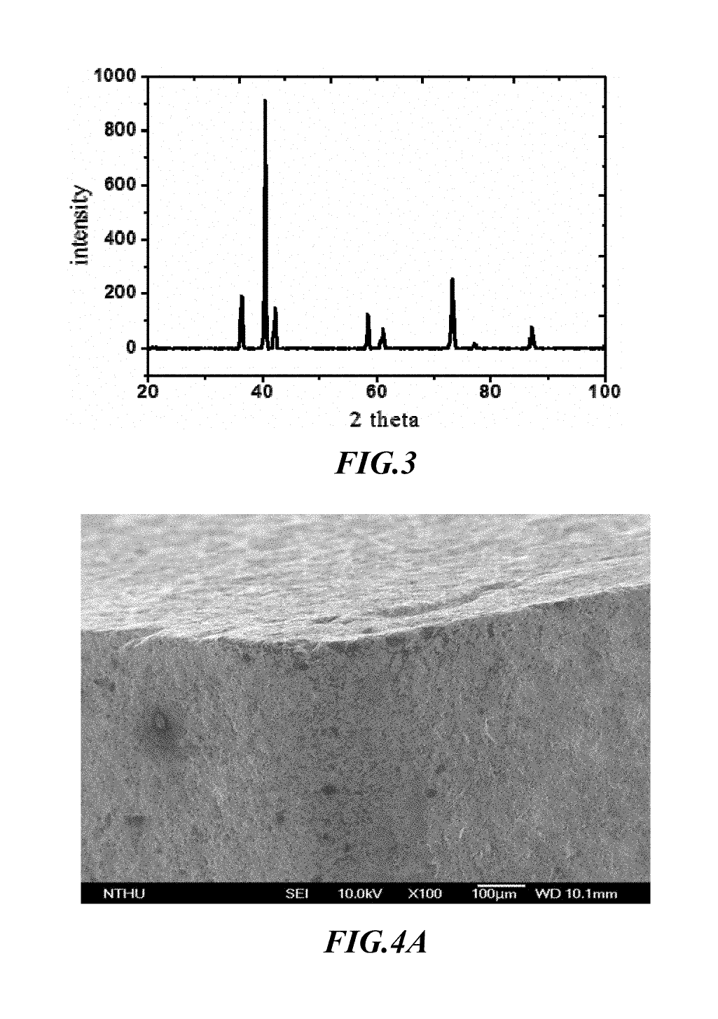

FIG. 3 shows an X-ray diffraction pattern of a multi-component composite material according to one embodiment of the present disclosure. FIG. 3 shows that the four phases in FIG. 2A and FIG. 2B are all formed by TiC and the solid solution TiₓW₁₋ₓ. Thus, the peaks 1, 2, 5, and 7 in FIG. 5 are the diffraction peaks of the component TiC, and the peaks 3, 4, 6, and 8 are the diffraction peaks of the component TiₓW₁₋ₓ.

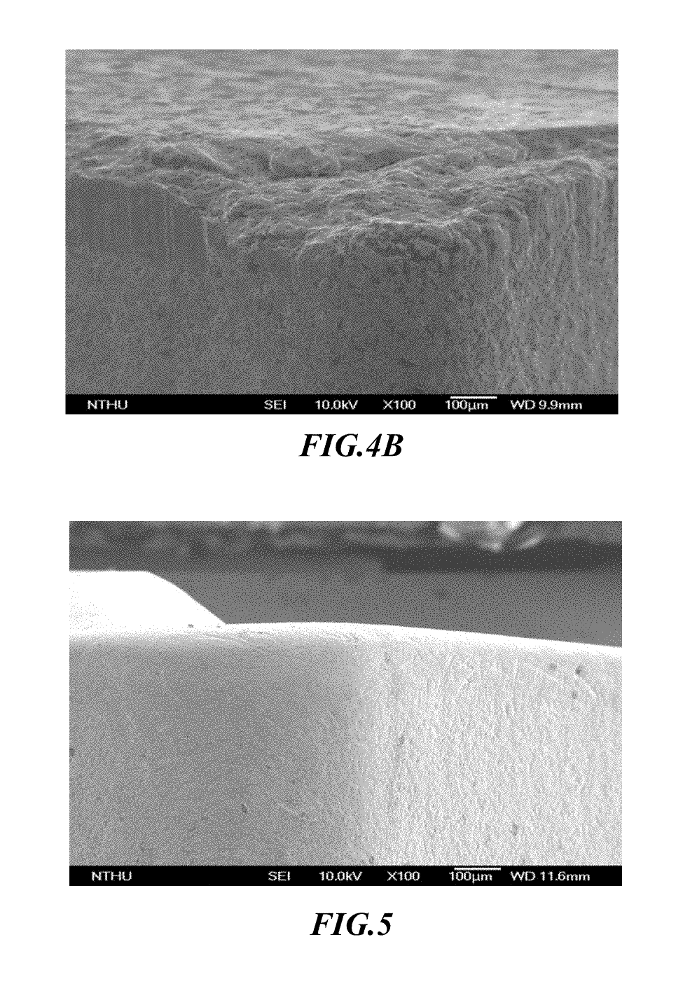

FIG. 4A and FIG. 4B show the enlarged photos of the surfaces of the turning tools made of the multi-component composite material according to one embodiment of the present disclosure. FIG. 4A shows the photo after the linear cutting, and FIG. 4B shows the photo after being used in turning 304 stainless steel by 8 mm. As shown in the figures, the turning tool that is prepared with the linear cutting though not going through the smoothing processes (such as polishing processes) is still good at cutting.

FIG. 5 shows an enlarged photo of the surface of the commercial turning tool made of the multi-component composite material according to one embodiment of the present disclosure. As shown in FIG. 5, the surface is smooth despite only suited for cutting 3 mm every single pass.

The “m” of the multi-component composite material mAnB may be 1, 2, 3, 4, 5, 6, 7, 8, 9, 10, 11, or 12, and the “n” of the multi-component composite material mAnB may also be 1, 2, 3, 4, 5, 6, 7, 8, 9, 10, 11, or 12, in which m+n may be 2, 3, 4, 5, 6, 7, 8, 9, 10, 11, 12, or 13.

TABLE 1
Test numbers and the compositions of the exemplary multi-component
composite materials of the present invention.

| Test No. | Composition |
|---|---|
| C1M1 | (TiC)_{0.6}W_{0.4} |
| C2M1 | [(TiC)(ZrC)]_{0.6}W_{0.4} |
| C3M1 | [(TiC)(ZrC)(NbC)]_{0.6}W_{0.4} |
| C4M1 | [(TiC)(ZrC)(NbC)(VC)]_{0.6}W_{0.4} |
| C5M1 | [(TiC)(ZrC)(NbC)(VC)(TaC)]_{0.6}W_{0.4} |
| C6M1 | [(TiC)(ZrC)(NbC)(VC)(TaC)(WC)]_{0.6}W_{0.4} |
| C7M1 | [(TiC)(ZrC)(NbC)(VC)(TaC)(WC)(HfC)]_{0.6}W_{0.4} |
| C6aM1 | [(TiC)(ZrC)(NbC)(TaC)(WC)(HfC)]_{0.6}W_{0.4} |

A vacuum arc melting furnace was used to form alloys with the compositions in Table 1. After the compositions were put in the furnace, the furnace was vacuumed to 2.4×10⁻² torn then pure argon was injected to about 8.0 torr, and the furnace was vacuumed again. Repeat the purge process three times before smelting. The smelting current was 550 amps. After smelting, the alloys were completely cooled and then turned over for smelting again. The smelting process was repeated no less than four times to ensure that all of the cermet elements are uniformly mixed in the alloys. Finally, after the alloys were complete cooled, the alloys were taken out of the vacuumed furnace and used as test samples.

After that, each test sample was tested for its overall hardness, toughness, and wear resistance, which were compared with commercial WC-Co test samples. The comparison results are shown in Table 2 below.

TABLE 2
Overall hardness, toughness, and wear resistance of each test sample.

| | Overall Hardness | | Wear Resistance |
|---|---|---|---|
| Test No. | (HV) | Toughness (K_{IC}) | (m/mm³) |
| C1M1 | 1700 ± 70 | 8.36 ± 0.5 | 151.87 ± 6.75 |
| C2M1 | 1483 ± 45 | 8.24 ± 0.6 | 28.24 ± 1.96 |
| C3M1 | 1626 ± 42 | 8.44 ± 0.1 | 49.67 ± 5.51 |
| C4M1 | 1945 ± 59 | 8.07 ± 0.6 | 105.5 ± 5.20 |
| C5M1 | 1956 ± 47 | 6.93 ± 0.2 | 160.94 ± 7.85 |
| C6M1 | 2033 ± 19 | 7.51 ± 0.2 | 155.99 ± 9.77 |
| C7M1 | 1661 ± 50 | 10.78 ± 0.6 | 102.18 ± 8.61 |
| C6aM1 | 1414 ± 30 | 11.44 ± 0.6 | 21.96 ± 2.01 |
| WC-Co | 1531 ± 52 | 13.28 ± 0.5 | 205.31 ± 5.31 |

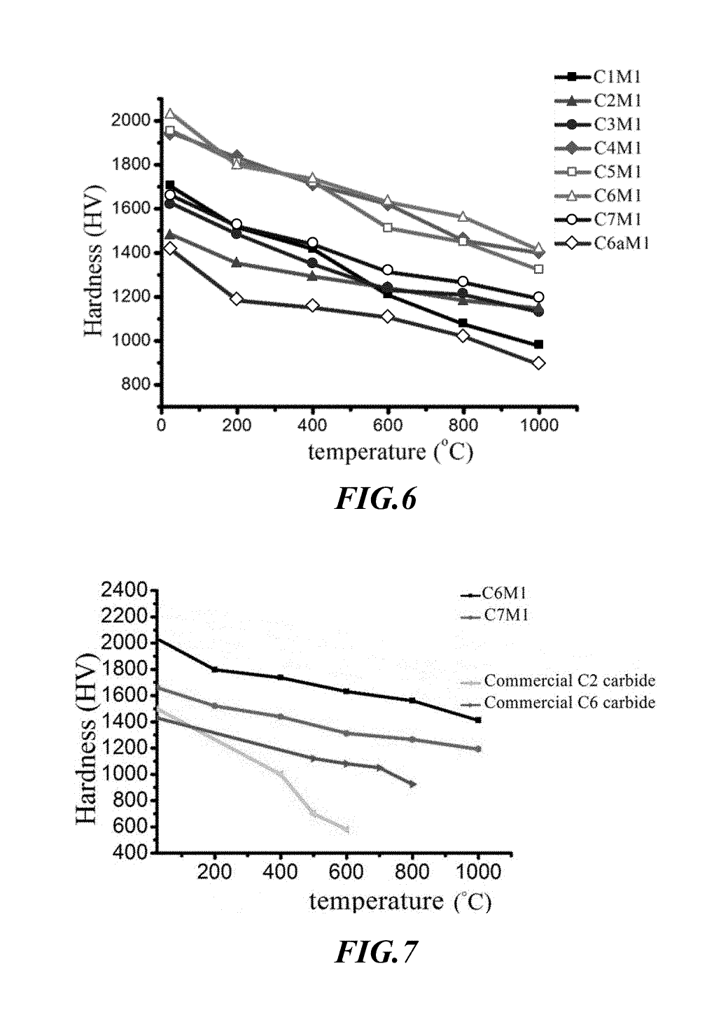

The hardness of the samples was tested at room temperature, 200° C., 400° C., 600° C., 800° C., and 1000° C., and the results are shown in FIG. 6. According to FIG. 6, the hardness of all the test samples slightly decreases as the temperature increases. Furthermore, as shown in FIG. 7, comparing two representative samples, C6M1 and C7M1, to two commercial carbides (C2 and C6), the alloys of the present invention have higher hardness at high temperatures (200° C. to 1000° C.).

In addition, the amounts of the above-mentioned ceramic compounds A and the bonding refractory metals B may have the same molars or different molars. Furthermore, if two or more ceramic compounds A are used, the amounts of each of the ceramic compounds A can be the same or different. If two or more bonding refractory metals B are used, the amounts of each of the bonding refractory metals B can be the same or different.

Comparing with the conventional techniques, the refractory metal-matrix ceramic compound multi-component composite material with the super-high melting point has the advantages as follows:

1. For increasing the melting point of the composite material, the refractory bonding metal in this disclosure replaces the common metal for serving as the cement agent. Additionally, because of the use of the refractory bonding metal as the cement metal, the high-temperature smelting processes for fusing the compounds and the refractory bonding metals may be employed. The generated product not only has the property of the high melting point, but also has the advantages of high hardness, high strength, and high ductility.

2. Also because of the use of the refractory bonding metal for replacing the common metal for serving as the cement agent, the smelting process rather than the sintering process could be used for manufacturing, resulting in the simplified manufacturing process and reduced manufacturing costs.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A refractory metal-matrix ceramic compound multi-component composite material, in which at least one ceramic compound A and at least one refractory bonding metal B are fused together by a smelting process to make the multi-component composite material, wherein fused ingredients of the multi-component composite material are mAnB, 2≤(m+n)≤13, m is a number of the added ceramic compounds, n is a number of the added refractory bonding metal B, m and n are positive integers, and an absolute value of combining enthalpy of the elements in ceramic compound A is larger than an absolute value of combining enthalpy of the nonmetal element in ceramic compound A and the refractory bonding metal B; the ceramic compound A is selected from the group consisting of a carbide, a nitride, a boride, and a silicide; the carbide is selected from the group consisting of titanium carbide (TiC), tantalum carbide (TaC), hafnium carbide (HfC), zirconium carbide (ZrC), niobium carbide (NbC) vanadium carbide (VC), chromium carbide (Cr₂C₃), and molybdenum carbide (Mo₂C); the nitride is selected from the group consisting of titanium nitride (TiN), zirconium nitride (ZrN), hafnium nitride (HfN), tantalum nitride (TaN), vanadium nitride (VN), and niobium nitride (NbN); the boride is selected from the group consisting of titanium boride (TiB₂), zirconium boride (ZrB₂), hafnium boride (HfB₂), tantalum boride (TaB₂), tungsten boride (WB), chromium boride (Cr₃B₂), molybdenum boride (MoB₂), and tungsten boride (W₂B); the silicide is selected from the group consisting of tantalum silicide (TaSi₂), titanium silicide (Ti₅ Si₃), zirconium silicide (Zr₆Si₅), niobium silicide (NbSi₂), molybdenum silicide (MoSi₂), and tungsten silicide (WSi₂); and the refractory bonding metal is selected from the group consisting of tungsten (W), rhenium (Re), tantalum (Ta), niobium (Nb), and molybdenum (Mo).

2. The refractory metal matrix-ceramic compound multi-component composite material according to claim 1, wherein a maximum mixture proportion and a minimum mixture proportion of each of the main ingredients of the multi-component composite material are respectively 93 wt % and 7 wt %.

3. The refractory metal-matrix ceramic compound multi-component composite material according to claim 1, wherein the refractory bonding metal B is soluble with respect to the ceramic compound A.

4. The refractory metal matrix-ceramic compound multi-component composite material according to claim 1, wherein a plurality of minor elements are added into the fused ingredients of the multi-component composite material.

5. The refractory metal matrix-ceramic compound multi-component composite material according to claim 1, wherein the multi-component composite material is processed by a coating process.

6. The refractory metal matrix-ceramic compound multi-component composite material according to claim 5, wherein a material of the coating process is MCrAlY or CoCrAlY.
